(19) United States
(12) Patent Application Publication
(10) Pub. No.: US 2004/0262457 A1
(43) Pub. Date: Dec. 30, 2004

(54) Inflatable Parachute for Decelerating an Object Entering the Earth Atmosphere from the Outer Space

(75) Inventor: Xiaoshi Charlie Jiang, Attleboro, MA (US)

Correspondence Address: XIAOSHI CHARLIE JIANG, 15 KNOWLTON CIRCLE, UPTON, MA, 01568, US

(73) Assignee: xiaoshi charlie jiang, attleboro, MA (US)

(21) Appl. No.: 10/249,556

(22) Filed: Apr. 17, 2003

(51) Int. Cl. B64D 17/00

(52) U.S. Cl. 244/145

(57) ABSTRACT

The disclosed invention is a drag area inflatable parachute for decelerating an object entering the earth atmosphere from the outer space. This parachute comprises an inflatable canopy, suspension lines, and a means to inflate the canopy by releasing gas or air between the canopy inner and outer layers. The canopy is inflated in the outer space where the air is thin.

### BACKGROUND OF INVENTION

When a man-made object entering the earth atmosphere from the outer space of the earth with very high speed, the friction between the object and the air generates extreme high heat. It is very expensive and difficult to make the object to withstand such high heat. Otherwise the object will be burnt out in the atmosphere. In case of a space shuttle, even it can survive the high heat; the communication between the shuttle and the earth control center will be interrupted by the heat. It is a very costly and dangerous event when a man-made object re-entering the earth atmosphere.

It is known that earth satellites are slowed down by the thin air in the space.

Because the air is too thin in the outer space, a regular parachute can not be deployed properly and provide the desired the drag force.

This invention will inflate the parachute canopy in the outer space for proper deployment, so it will provide the needed drag force when the object is approaching the earth upper atmosphere to decelerate the object.

### SUMMARY OF INVENTION

The invention consists of a parachute with an inflatable canopy and a means to store and release the gas or air into the chambers between the canopy inner and outer layers, so that the parachute can be deployed in the outer space.

This parachute will provide the drag force to decelerate the attached man-made object as the object entering the earth atmosphere.

The parachute can be launched from a storage compartment on the man-made object by compressed air.

### BRIEF DESCRIPTION OF DRAWINGS

FIG. 1. shows a side view of the parachute with the inflatable canopy and the attachments.

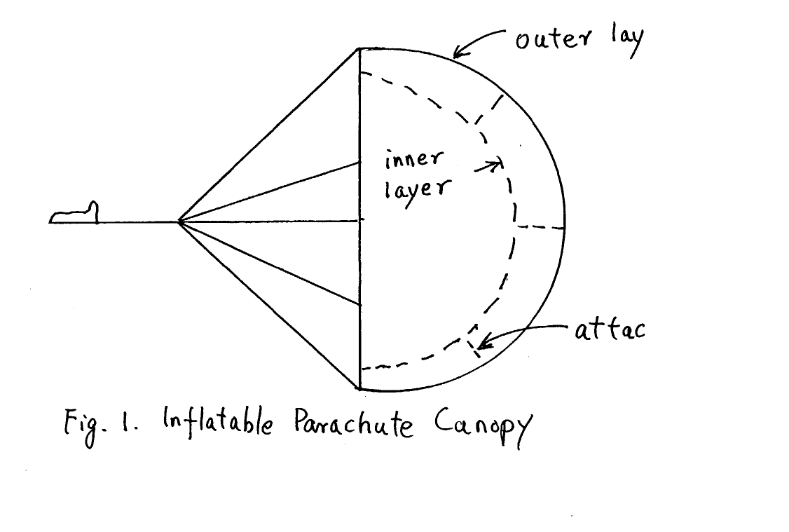

### DETAILED DESCRIPTION

This parachute consists of an inflatable canopy, which is inflated by releasing air or gas into the air chambers between the canopy inner and outer layers.

The distance between the canopy inner and outer layers are constrained by attachments to prevent the inner layer separated from outer layer beyond certain distance.

The parachute is fully deployed before the attached man-made object entering the thicker earth atmosphere.

The inflatable parachute can be designed as a hang glider to maneuver the man-made space object to a landing zone.

The speed of the attached man-made object will be slowed down to prevent the high heat produced from the atmosphere air friction.

The air pressure does not have to be too high to inflate the canopy in the outer space, because there is virtually no air pressure.

The inflation air or gas has two main purposes; to inflate the canopy and to collide with the atmosphere air molecules to prevent the air penetration on the canopy outer layer.

The air chambers between the canopy inner and outer layers may be inflated sequentially. The canopy inner layers do not have to cover the whole area of the outer layer.

1. A decelerate parachute device comprising an inflatable parachute canopy having a means attachable to an object entering the earth atmosphere from the outer space and a means mounted on the parachute to release gas or air between the canopy inner and outer layers to inflate the canopy.

2. The parachute of claim 1, wherein the said inflatable canopy inner layer attached to the outer layer at multiple locations to control the distance between the two layers.

3. The parachute of claim 1, wherein the said means to release the gas or air between the canopy inner and outer layers can be one entity or multiple entities mounting anywhere on the parachute.

4. The inflatable canopy of claim 2, wherein the space between the inner and outer layers of the canopy may be partitioned as one or more air chambers.
